(19) United States
(12) Patent Application Publication
(10) Pub. No.: US 2005/0275335 A1
(43) Pub. Date: Dec. 15, 2005

(54) Image display apparatus

(75) Inventors: Akira Hayama, Atsugi-shi (JP); Taro Hiroike, Yamato-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/136,517

(22) Filed: May 25, 2005

(30) Foreign Application Priority Data
Jun. 1, 2004 (JP) 2004-162967(PAT.)
May 18, 2005 (JP) 2005-145081(PAT.)

(51) Int. Cl. H01J 1/62; H01J 63/04

(52) U.S. Cl. 313/495; 313/497; 313/496

(57) ABSTRACT

An image display apparatus is provided, in which spacers are interposed between a face plate and a rear plate without affecting an image quality, and an anti-atmospheric pressure measure is taken for the interior of a display panel. The image display apparatus has a spacer, which is disposed in the interior of a vacuum container so as to abut against a first substrate and a second substrate, and comprises base material and a film having a resistance higher than a first electrode or a second electrode coating the base material,

wherein 0.3S1≦s1≦0.003A or 0.3 S2≦s2≦0.003A, where A is an inner cross sectional area of the container cut along a plane parallel with the first substrate of the vacuum container, S1 is a total area of the end portion adjacent and faced to the first substrate of the spacer, S2 is a total area of the end portion adjacent and faced to the second substrate of the spacer, S1 is an actual contact area with the spacer and the first electrode, and S2 is an actual contact area with the spacer and the second electrode.

### BACKGROUND OF THE INVENTION

1. Field of the Invention

The present invention relates to a flat-panel image display apparatus using an electron-emitting device.

2. Related Background Art

In recent years, in general, a flat-panel display using an electron-emitting device has been attracting attention as substitution of the display apparatus of a cathode-ray tube type since it occupies as little space as possible and is light in weight. The flat-panel image display apparatus constituted by using such an electron-emitting device has a rear plate disposed with an electron source comprising a plurality of electron-emitting devices disposed in opposition to a faceplate comprising a light-emitting member for emitting light by irradiation of electrons emitted from the electron-emitting devices on the rear plate through a side wall, and forms a peripheral vessel (air-tight container) to maintain the inside evacuated.

The interior of the air-tight container is kept evacuated at a degree of vacuum of approx 10⁻⁴ Pa, and as the display area of the image display apparatus becomes larger, means for preventing deformation or breakage of the rear plate and the face plate due to pressure difference between the interior of the air-tight container and the outside is required. Thickening the rear plate and face plate not only increases the weight of the image display apparatus, but also causes an image distortion and an azimuth difference when seen from an oblique direction. Hence, usually, as shown in Patent Document 1, this problem is dealt with by disposing a spacer (referred to also as structural support member or rib) between the face plate and rear plate so as to become a predetermined occupancy ratio in the interior of the display apparatus.

The spacer disposed in the interior of the air-tight container must not sharply affect the trajectory of the electrons flying between the rear plate and the face plate. Responsible for affecting the electron trajectory is static or dynamic electric field alternation due to charge in the vicinity of the spacer, which is generated by the existence of the spacer. The charge of the spacer is believed to develop in such a manner that a part of electrons emitted from the electron-emitting device or the electrons reflected by the face plate are incident on the spacer, and secondary electrons are emitted from the spacer, or ion ionized by collision of electrons is adhered on the surface.

When the spacer is positively charged, the electrons flying in the vicinity of the spacer are attracted by the spacer, and this causes the distortion of the display image in the vicinity of the spacer. The effect of the charge becomes remarkable as the intervals between the rear plate and face plate increase.

In general, as means for controlling the charge, the charged surface is given conductivity, and some amount of current is let flow so as to eliminate the charge. A technique, in which this concept is applied to the spacer and the surface of the spacer is coated with tin oxide, is disclosed in Patent Document 2. Further, in Patent Document 3, there is disclosed a technique in which the spacer is coated with PdO system glass material. Further, in Patent Document 4, the abutting surfaces with the rear plate and the face plate of the spacer are formed with electrode so that an electric field is uniformly applied on the surface of the spacer, thereby preventing the breakage of the spacer due to connecting failure and concentration of current.

[Patent Document 1] Japanese Patent Application Laid-Open No. 2000-260353 (U.S. Pat. No. 6,541,900)

[Patent Document 2] Japanese Patent Application Laid-Open No. H57-118355

[Patent Document 3] Japanese Patent Application

[Patent Document 4] Japanese Patent Application Laid-Open No. H08-180821 (U.S. Pat. No. 5,760,538)

Although, in a conventional display panel, the spacer has an electrode provided for the abutting surfaces with the face plate and the rear plate, respectively, because of urging wishes for low cost such as simplification of structure, reduction of process, and the like, research works have been conducted to eliminate this electrode. However, in case the electrode of the spacer is eliminated, depending on contact states between the spacer and the face plate and between the spacer and the rear plate, the quality of an image has often been deteriorated. The research works conducted by the present inventor and others have newly revealed that the spacer not carrying the electrode shows an unintended distributional state in potential distribution of the surface or the charge of the spacer is not sufficiently reduced.

### SUMMARY OF THE INVENTION

An object of the present invention is to provide an image display apparatus having solved the above described problem, and specifically, it is to provide an image display apparatus which prevents the occurrence of an unintended potential distribution and charge on the spacer surface and controls the effect of the spacer to the image quality.

The present invention is an image display apparatus characterized by comprising:

a vacuum container comprising a first substrate having a first electrode, and a second substrate having a second electrode set at a potential higher than the first electrode; and

a spacer which is disposed in the interior of the vacuum container so as to abut against the first substrate and the second substrate, and is constituted by a base material a film having resistance higher than and the first electrode or the second electrode coating the base material;

wherein 0.3S1≦s1≦0.003A or 0.3S2≦s2≦0.003A, where A is an inner cross sectional area of the container cut along a plane parallel with the first substrate of the vacuum container, S1 is a total area of the end portion adjacent and faced to the first substrate of the spacer, S2 is a total area of the end portion adjacent and faced to the second substrate of the spacer, s1 is an actual contact area with the spacer and the first electrode, and s2 is an actual contact area with the spacer and the second electrode.

### BRIEF DESCRIPTION OF THE DRAWINGS

FIGS. 1A and 1B are block diagrams of one example of an image display apparatus of the present invention;

FIG. 2 is a schematic illustration for explaining the advantage of the present invention;

FIGS. 3A and 3B are schematic diagrams of the simulation model of the potential distribution of a spacer according to the present invention;

FIG. 4 is a view showing a relation between the potential distribution on the spacer surface of FIGS. 3A and 3B and s1/S1 and s2/S2;

FIG. 5 is an oblique view of a display panel of one example of the image display apparatus of the present invention;

FIG. 6 is a top plan of one example of a multi-electron beam source constituting the image display apparatus of the present invention;

FIG. 7 is a top plan schematic illustration of one example of a fluorescent film used in the image display apparatus of the present invention;

FIG. 8 is a cross sectional schematic illustration of the display panel of FIG. 5;

FIG. 9 is a top plan schematic illustration of the image display apparatus of a second embodiment of the present invention;

FIG. 10 is a top plan schematic illustration of the image display apparatus of a third embodiment of the present invention;

FIG. 11 is a view showing the spacer used in the first embodiment of the present invention;

FIG. 12 is a view showing the spacer used in the third embodiment of the present invention;

FIGS. 13A and 13B are schematic illustrations of the spacer and a column directional alignment in a fourth embodiment of the present invention; and

FIGS. 14A and 14B are explanatory drawings of the spacer and the column directional alignment in the fourth embodiment of the present invention.

### DESCRIPTION OF THE PREFERRED EMBODIMENTS

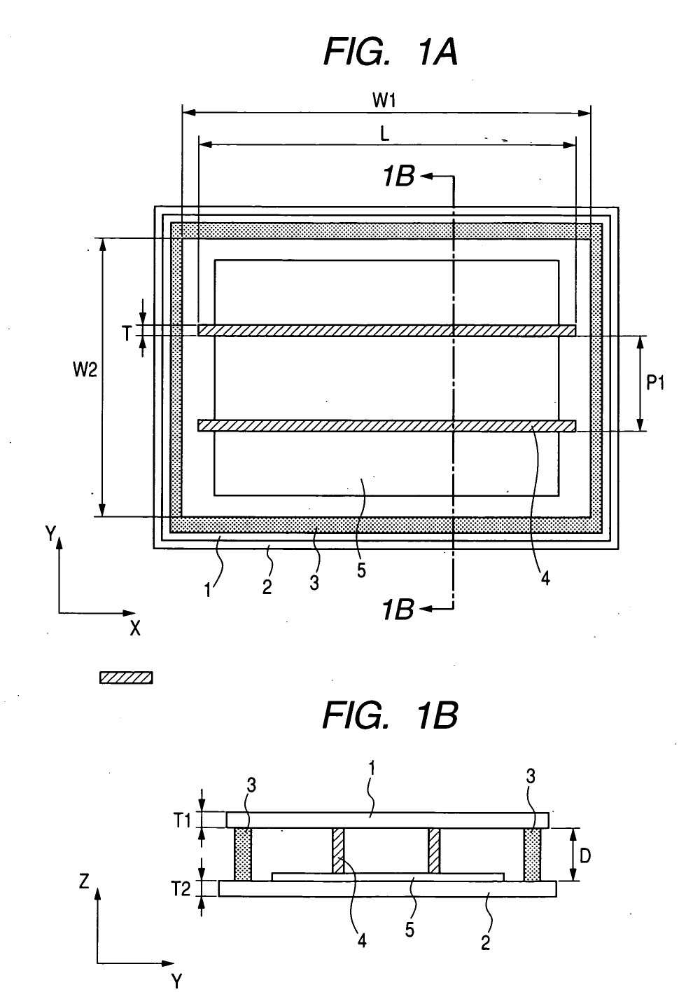

A limit of a ratio of an inner cross sectional area to a total contact area with the substrate of a spacer, which is the feature of the present invention, will be described by using FIGS. 1A to 4.

FIG. 1A is a schematic illustration showing a top plan structure in the image display apparatus of the present invention, and FIG. 1B is a cross sectional schematic illustration cut along the line 1B-1B of FIG. 1A. In the drawing, reference numeral 1 denotes a face plate (second substrate), reference numeral 2 a rear plate (first substrate), reference numeral 3 a side wall (frame portion), reference numeral 4 a spacer, and reference numeral 5 an electron-emitting region forming a plurality of electron-emitting devices.

In the image display apparatus of the present invention, the electron-emitting region 5 of the rear plate 2 which is the first substrate is formed with a plurality of electron emitting-devices (not shown), and the face plate 1 which is the second substrate is disposed on the inner side with an emitting-member (usually, fluorescent film, not shown in FIGS. 1A and 1B) for emitting light by irradiation of electrons emitted from the electron-emitting devices on the rear plate 2. A side wall 3 is a frame portion (inside dimension is W1 in the x direction, and W2 in the y direction) hermetically adhered to the face plate 1 and the rear plate 2 by frit glass. The spacer 4 is sheet-like (length L in the x direction, and length T in the y direction), which is disposed at intervals P1 in the y direction, and is interposed between the face plate 1 (second substrate) and the rear plate (first substrate) 2, and supports the external force by atmospheric pressure applied to the image display apparatus in the interior of the image display apparatus, and keeps a distance D between the two substrates constant.

The present inventors have studied the structure leading to the present invention by aiming at the following points so as to realize good electrical contacts between the face plate 1 and the rear plate 2 and the spacer 4.

Necessary conditions regarding the shape and alignment of the sheet-like spacer or the cylindrical spacer and the like is related to a ratio of the total area (S1) of the portion where the sparer 4 and the faceplate 1 are mutually adjacent and opposed to the actual contact total area (s1) of the portion where the spacer 4 and the face plate are actually contacted or a ratio of the total area (S2) of the portion where the sparer 4 and the rear plate 2 are mutually adjacent and opposed to the actual contact total area (s2) of the portion where the spacer 4 and the rear plate are actually contacted.

As described above, the spacer 4 supports the external force equivalent to the atmospheric pressure P (0.1 MPa) applied to the face plate 1 and the rear plate 2. The total loading capacity is equivalent to a loading (P×A) which is the atmospheric pressure multiplied by A (=W1×W2) being the inner cross sectional area of the image display apparatus. This loading is believed to be dispersed and supported by a plurality of spacers 4.

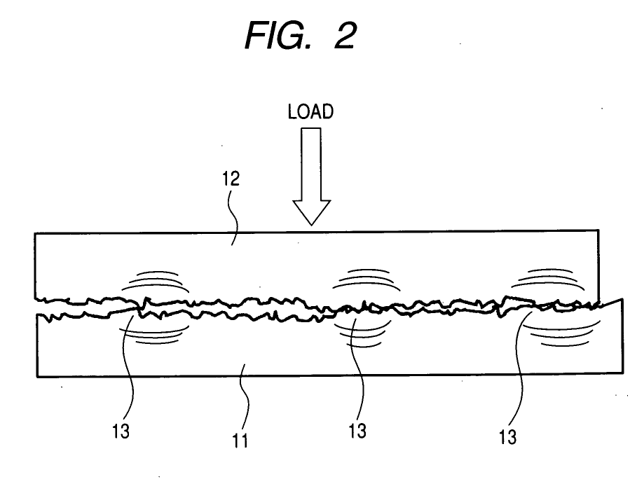

Here, contact between solid pieces will be descried by using FIG. 2. In the drawing, reference numerals 11 and 12 denote solid pieces being flat in the surface from visual observation, and reference numeral 13 a true contact point. However, no matter how flat it looks, the surface of the solid piece has unevenness if seen meticulously. Because of this unevenness, an actual contact area which is the area of the portion (this is referred to as actual contact point 13) where these two solid pieces 11 and 12 contact is extremely small comparing to the adjacent opposed area, and therefore, the pressure of the actual contact point 13 is extremely high. When the solid piece is distorted, a restoring force works, and in case the distortion is small, both are in proportion (Hooke's law). However, when the distortion becomes large, the proportional relation is broken, and a rate of increase of the restoring force becomes gradually small, and finally, the restoring force becomes at a constant value. The restoring force per unit area at this time is referred to as a plastic flow pressure Pf. It is believed that the restoring force reaches this plastic flow pressure at the actual contact point. Since the pressure is constant, the actual contact area for supporting a normal force N applied on the contact face between the solid pieces increases, and this is given by the expression: actual contact area=N/Pf (N: a normal force, Pf: a plastic flow pressure). That is, in the contact between the solid pieces, assuming that the normal force is constant, the actual contact area is not given by an adjacent opposed area, but by a constant value depending on the plastic flow pressure Pf decided by the contact surface state between the solid pieces.

In consideration of the aforesaid, in case the total area of the portion where the face plate 1 and the spacer 4 are mutually adjacent and opposed and the total area of the portion where the rear plate 2 and the spacer 4 are mutually adjacent and opposed are taken as S1 and S2, and each of the actual contact total area thereof are taken as s1 and s2, and moreover, the materials of the spacer 4 and the face plate 1 and the rear plate 2 are approximately uniform in the contact portions, s1 and s2 are constant without resource to S1 and S2, and are decided by softer material among from the spacer 4 and the face plate 1 and the rear plate 2 in the contact portion.

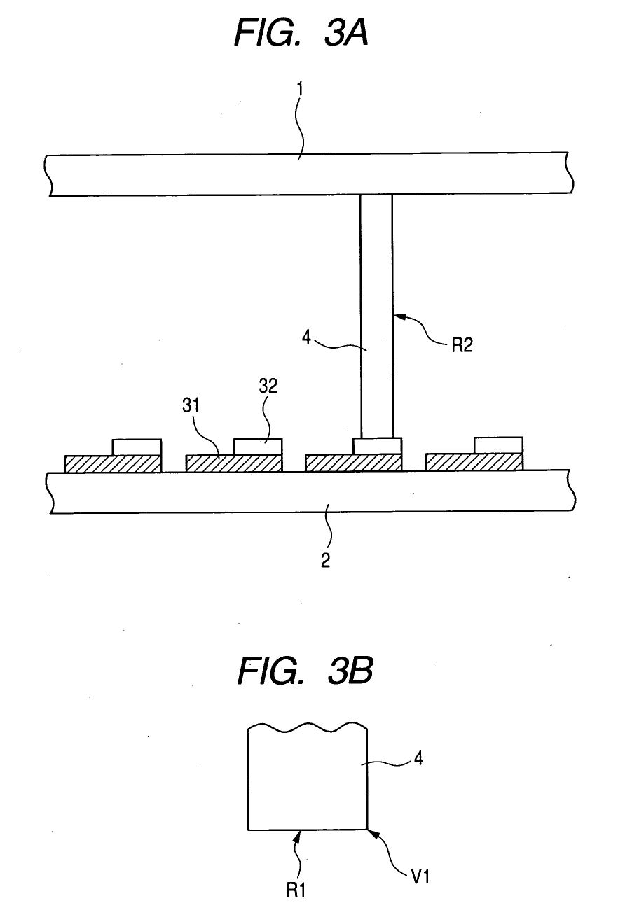

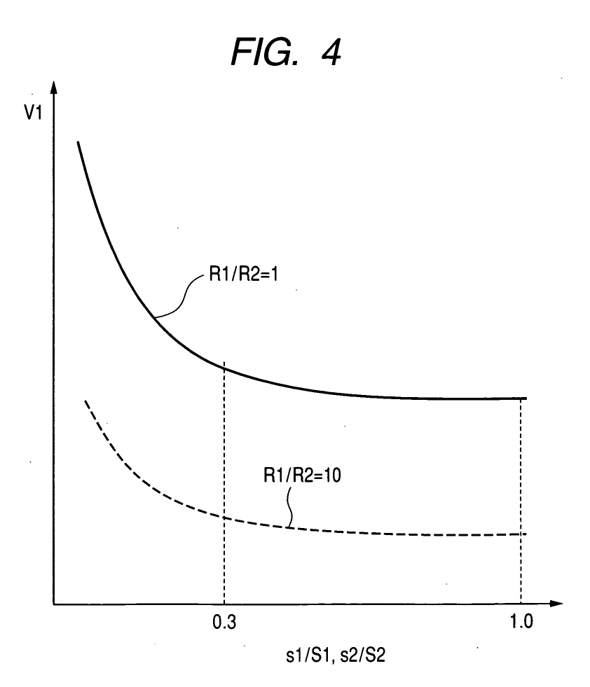

Here, the contact conditions between the spacer 4 and the face plate 1 and between the spacer 4 and the rear plate 2 are controllability of the potential control of the surface of the spacer. That is, in each spacer, by how much ratio the actual contact surface is required for the opposed area of the spacer to the real plate 1 or the face plate 2 has been examined in terms of electric connection. Then, the present inventors have conducted a simulation of potential distribution of the spacer 4 for the contact state between the spacer 4 and the face plate 1 and between the spacer 4 and the rear plate 2. FIG. 3A is a schematic diagram of a simulation model, and FIG. 3B is an enlarged view of the end portion of the spacer 4 of FIG. 3A. In the drawing, reference numeral 31 denotes a device electrode, and reference numeral 32 a column directional wiring. As a point representing the potential of the spacer 4 surface, potential V1 of the outermost region where the spacer 4 and the rear plate 2, and the spacer 4 and the face plate 1 are mutually adjacent and opposed has been selected. Since the potential V1 not only depends on the contact states between the spacer 4 and the face plate 1, and between the spacer 4 and the rear plate 2, but also depends on R1/R2 which is a ratio of a resistance R1 of the region, where the spacer 4 and the rear plate 2 and the spacer 4 and the face plate 1 are mutually adjacent and opposed, to a resistance R2 of the side surface of the spacer 4, the simulation has been conducted in the case of two types of R1/R2=1 and R1/R2=10. FIG. 4 shows a relation between the potential V1 of the outermost region where the spacer 4 and the real plate 2 and the spacer 4 and the face plate 1 representing the potential distribution of the spacer 4 surface are mutually adjacent and opposed, and s1/S1 and s2/S2. From this drawing, the following result has been obtained. That is, in the case of R1/R2=1, to control the potential distribution of the spacer 4 surface, regions where the change of the potential V1 is small are desirable as follows.
s1/S1>0.3
s2/S2>0.3
These conditions are also necessary and sufficient in the case of R1/R2>1.

Further, when the actual contact total area between the spacer 4 and the face plate 1, and the spacer 4 and the rear plate 2 in an ideal state applied with the atmospheric pressure is measured by a hardness meter (Nano Indenter of MTS Systems Corporation, USA) in ordinal material (ceramics such as soda lime glass, aluminum and the like for the spacer, and silver, aluminum, copper, and the like for the face plate and the rear plate abutting portion), the result is as follows
s1/A≦0.003
s2/A≦0.003
and in this case, it is confirmed that the necessary and sufficient force is applied to obtain an excellent electric connection between the spacer and the electrode structure of the face plate and the rear plate.

From the aforementioned, in the image display apparatus, it is desirable that
0.3S1≦s1≦0.003A or 0.3S2≦s2≦0.003A
The present invention is characterized by using the spacer falling under this range.

Specifically, as described in the following embodiment, to satisfy this relation, the shape of the opposed surface of the spacer to the rear plate or the face plate is elaborated so as to secure a sufficient volume capable of enduring a buckling as the spacer, while reducing the total areas S1 and S2 of the adjacent and opposed surface, thereby making it possible to satisfy 0.3S1 (0.3S2)≦s1 (s2) as well as s1 (s2)≦0.003A. Further, as another method, the shape of the opposed surface to the spacer of the rear plate or the face plate is elaborated so as to satisfy the above described relation.

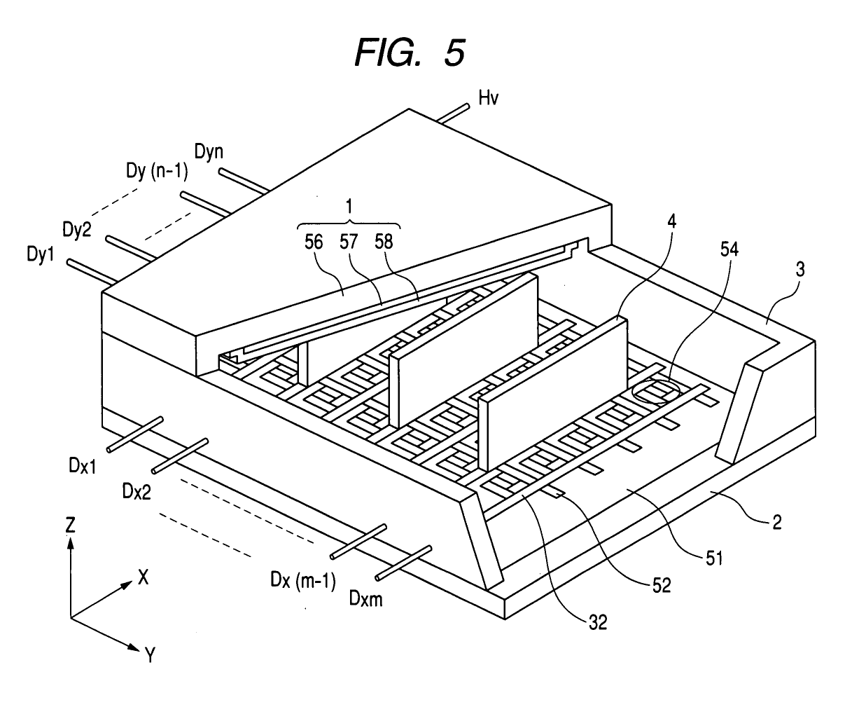

Next, a display panel of the image display apparatus of the present invention will be described by using FIG. 5. FIG. 5 is an oblique view of the display panel of one embodiment of the image display apparatus of the present invention, and shows a partially broken panel to show the internal structure thereof. In the drawing, reference numeral 1 denotes a face plate, which provides a fluorescent film 57 and a metal back 58 in the inside of a glass substrate 56. Reference numeral 51 denotes an electron source substrate, which comprises a plurality of electron emitting devices 54, row directional wirings 32, and column directional wirings 52. Reference numeral 2 denotes a rear plate, reference numeral 3 a side wall, which forms an air-tight container for keeping the interior of the display panel vacuum by the face plate 1, the rear plate 2 and the side wall 3. On the occasion of assembling the air-tight container, though the container is required to be sealed to maintain sufficient strength and air-tightness at the junction of each member, for example, the junction is coated with frit glass, and is sintered at 400 to 500° C. for more than ten minutes in the atmosphere or nitrogen atmosphere, thereby achieving the sealing. A method of evacuating vacuum the interior of the air-tight container will be described later. Since the interior of the air-tight container is kept vacuum at approx 10⁻⁴ Pa, the spacer 4 is provided as an anti-atmospheric structure for the purpose of preventing the breakage of the air-tight container by atmospheric pressure or abrupt shock.

While the rear plate 2 is formed with the electron source substrate 51, on the substrate 51, there are formed with the electron-emitting devices 54 of n×m pieces (n and m are integer of more than number two, and are adequately set according to the number of the object display devices. For example, in the display device aiming at display of high-definition television, it is desirable to set the number of devices of n=3000 and m=1000 or more). The electron-emitting devices of n×m pieces are wired in a simple matrix pattern by the row directional wirings 32 of m pieces and the column directional wirings 52 of n pieces. The portion constituted by the electron-emitting substrate 51, the electron-emitting device 54, the row directional wiring 32, and the column directional wiring 52 is referred to as multi-electron beam source.

The multi-electron beam source used in the image display apparatus of the present invention is not limited in material, shape or production method of the electron-emitting device 54 if it is the electron source, which wires the electron-emitting devices 54 in a simple matrix pattern. Consequently, for example, a cold-cathode device such as a surface conductive electron-emitting device, a FE type or MIM type device can be used.

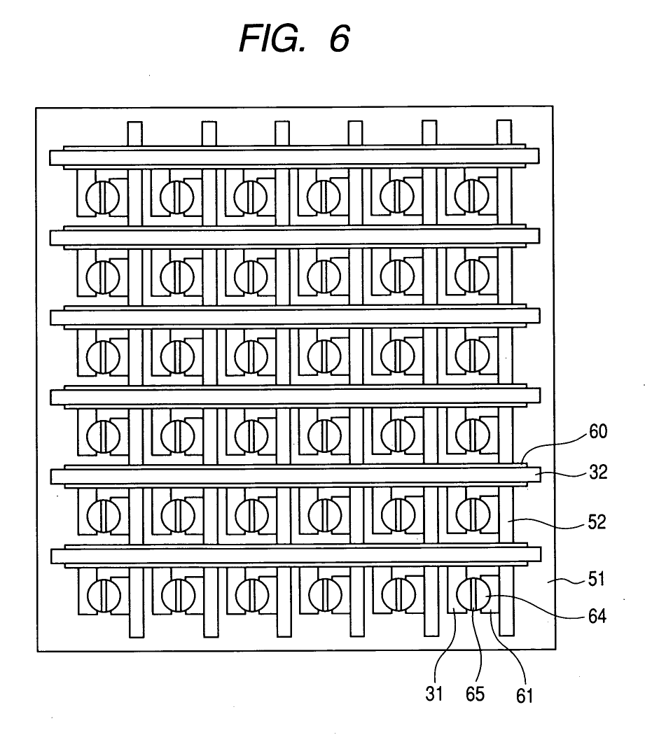

Next, the structure of the multi-electron beam source, which disposes the surface conductive electron-emitting devices on the substrate 51 as the electron-emitting devices 54 and wires them in the simple matrix pattern will be described by using FIG. 6. In the drawing, reference numeral 60 denotes an interlayer insulating layer, reference numeral 61 a device electrode, reference numeral 64 a conductive thin film, and reference numeral 65 an electron-emitting portion.

FIG. 6 is a top plan schematic illustration of one example of the multi-electron beam source used in the display panel in FIG. 5. On the electron source substrate 51, there are disposed the surface conductive electron-emitting devices, and these devices are wired in a simple matrix pattern by the row directional wirings 32 and the column directional wirings 52. Below the row direction wirings 32, there are formed the interlayer insulating layers 60, in which electric insulation with the column directional wirings 52 are maintained.

The multi-electron beam source constituted as described above forms the row directional wirings 32, the column directional wirings 52, the interelectrode insulating layers 60, device electrodes 31 and 61 of the surface conductive electron-emitting devices, and conductive thin films 64 on the substrate 51 in advance, and after that, feeds each device through the row directional wirings 32 and the column directional wirings 52 so as to perform an energizing forming processing and an energizing activation processing, thereby forming the electron-emitting portions 65. Thus, the multi-electron beam source is produced.

In the present embodiment mode, the rear plate 2 of the air-tight container is fixed with the substrate 51 of the multi-electron beam source. However, in case the substrate 51 of the multi-electron beam source has sufficient strength, the substrate 51 itself of the multi-electron beam source may be used as the rear plate 2 of the air-tight container.

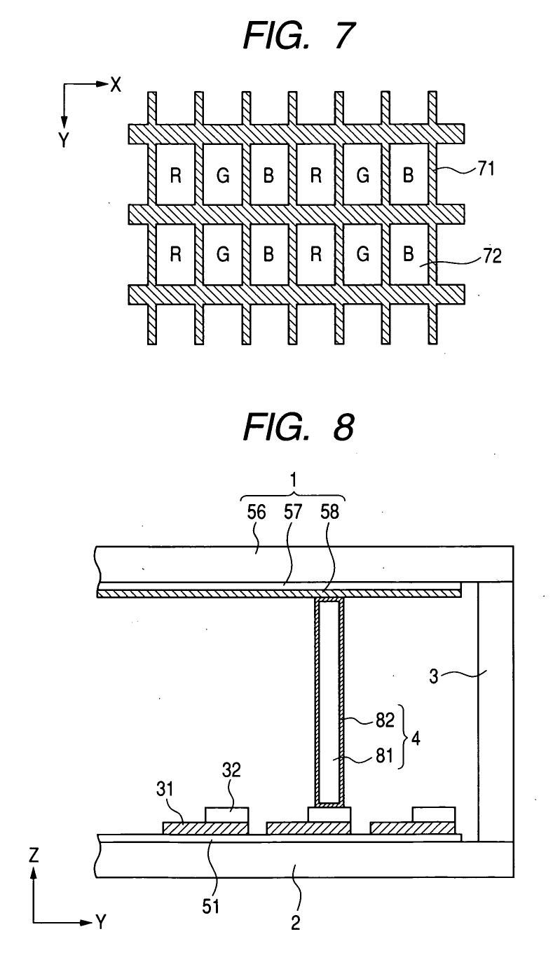

FIG. 7 is a top plan schematic illustration of one example of the fluorescent film 57 which is a constituent member of the face plate 1. In the drawing, reference numeral 71 denotes a black color conductive material, and reference numeral 72 a fluorescent material.

Further, on the surface at the rear plate 2 side of the fluorescent film 57, there is provided with a metal back (second electrode) 58 publicly known in the field of CRT.

Further, though not used in the present mode, there may be provided, for example, a transparent electrode with ITO as material between the glass substrate 56 and the fluorescent film 57 for the purpose of applying a velocity voltage and improving the conductivity of the fluorescent film.

FIG. 8 is a cross sectional schematic illustration in a Y direction passing through the device electrode 31 connected to the row directional wiring 32 in the display panel of FIG. 5. In the drawing, reference numeral 81 denotes an insulative base material, and reference numeral 82 a high resistance film.

The spacer used in the present invention is comprised by covering the base material by a film having a resistance higher than the first electrode or the second electrode, and a sheet resistance of the high resistance film is preferably 10⁷ to 10¹⁴ Ω/□.

The spacer 4 of the present embodiment has the high resistance film 82 formed on the surface of the insulative base material 81 for the purpose of controlling the potential on the surface of the spacer 4 and improving charge prevention. The spacer 4 is disposed for the necessary number of pieces at necessary intervals to achieve the object of preventing the breakage of the air-tight container by the atmospheric pressure, an abrupt shock and the like. In the mode described here, the shape of the spacer 4 is a thin sheet-like, and the spacer 4 is disposed parallel with the row directional wiring 32, and is electrically connected to the row directional wiring 32.

It is desirable that the spacer 4 has insulation properties endurable enough to sustain high voltage applied between the row directional wiring 32 and the column directional wiring 52 on the substrate 51 and the metal back 58 on the inner surface of the face plate 1, and moreover, has conductivity to the extent of preventing the charge from spreading to the surface of the spacer 4. This is because, if the spacer 4 is charged, the electrons flying in the vicinity of the spacer 4 are attracted by the spacer 4, thereby causing distortion to the display image in the vicinity of the spacer 4.

As the insulative base material 81 of the spacer 4, a ceramic member and the like such as glass, soda lime glass, aluminum, and the like which reduces impurity content such as, for example, silica glass, Na, and the like can be cited. The insulative base material 81 preferably has its coefficient of thermal expansion close to the member comprising the air-tight container and the material 51.

In the high resistance film 82 formed on the surface of the insulative base material 81, there is let flow the current dividing a velocity voltage Va applied to the face plate (metal back 58 and the like) 1 at the high potential side by a resistance value Rs of the high resistance film 82. Then, the resistance value Rs of the high resistance film 82 is set to its desirable range in terms of the charge prevention and the power consumption. In terms of the charge prevention, the sheet resistance □ of the high resistance film 82 is preferably below 10¹⁴ Ω/□. To obtain a sufficient charge prevention effect, the sheet resistance is more preferably below 10¹³ Ω/□. Although the lower limit of the sheet resistance depends on the voltage applied between the spacer shape and the spacer, it is preferable that the sheet resistance is 10⁷ Ω/□ or more.

The thickness of the high resistance film 82 formed on the insulative base material 81 is desirable to be in the range of 10 nm to 1 μm. Although being different depending on the surface energy and adhesiveness with the insulative base material 81 of the material or the substrate temperature, in general, the thin film below 10 nm is formed island-shaped, and its resistance is unstable and its duplicability is poor. In the meantime, when the film thickness is 1 μm or more, a film stress becomes large so as to increase a risk of film peeling, and moreover, a film forming takes a long time, which cuts into productivity. Consequently, the film thickness is desirable to be 50 to 500 nm.

The sheet resistance R/□ is ρ/t, and from the above described preferable range of R/□ and the film thickness, a specific resistance ρ of the high resistance film 82 is preferably 0.1 to 10⁸ Ω·cm. Further, to realize a preferable range of the surface resistance and the film thickness, ρis preferably 10² to 10⁶ Ω·cm.

As the material of the high resistance film 82, metal oxide is excellent. Among from metal oxides, oxides of chrome, nickel, and copper are preferable material. The reason why is because it is believed that these oxides are relatively small in secondary electron emitting efficiency, and even in case the electrons emitted from the electron-emitting device hit upon the spacer 4, the oxides are hard to be charged. Carbon, other than the metal oxide, is small in the secondary electron emitting efficiency, and is a preferable material. Particularly, since amorphous carbon is of high resistance, the resistance of the spacer 4 is easily controlled to a desired value.

However, since the metal oxide or carbon has its resistance value hard to be adjusted to the desired specific resistance range as the high resistance film 82 or its resistance to change by the atmosphere, the controllability of the resistance is poor by these materials alone. Nitride of aluminum and transition metal alloy can control the resistance value from good conductor to insulator in a wide range by adjusting the composition of the transition metal. Further, in the step of preparing the display device to be described later, nitride scarcely changes in the resistance value, and is a stable material. In addition, its resistance temperature coefficient is below −1%, and it is a material practically easy to be used. As the transition metal element, Ti, Cr, Ta, and the like can be cited.

In FIG. 5, Dx1 to Dxm and Dy1 to Dyn and Hv are electric connection terminals having an air-tight structure provided to electrically connect the display panel and the electric circuit (not shown). Dx 1 to Dxm are electrically connected to the row directional wirings 32 of the multi-electron beam source, Dy1 to Dyn to the column directional wirings 52 of the multi-electron beam source, and Hv to the metal back 58 of the face plate 1.

Further, to evacuate vacuum the air-tight container, after assembling the air-tight container, an exhaust pipe (not shown) and a vacuum pump are connected, and then, the interior of the air-tight container is evacuated vacuum to the extent of approx 10⁻⁵ Pa. After that, though the exhaust pipe is sealed, to maintain a degree of vacuum inside the air-tight container, immediately before or after the sealing, a getter film (not shown) is formed at a predetermined position in the interior of the air-tight container. The getter film is a film which is formed by heating and evaporating a getter material mainly comprising, for example, Ba by heater or high frequency heating, and by absorptive operation of the getter film, a degree of vacuum of 1×10⁻³ to 1×10⁻⁵ Pa is maintained inside the air-tight container.

When the image display apparatus using the display panel as described above applies the voltage to each electron-emitting device 54 through the container outer terminals Dx1 to Dxm and Dy1 to Dyn, the electrons are emitted from each electron-emitting device 54. At the same time, the apparatus applies a high pressure of several hundreds V to several thousands V to the metal back 58 through the container outer terminal Hv so as to accelerate the emitted electrons, and allows them to hit upon the inner surface of the face plate 1. In this manner, each color fluorescent material composing the fluorescent film 57 is excited to emit light, thereby displaying an image.

Usually, the applied voltage to the electron-emitting device 54 is approximately 12 to 16V, and the distance between the metal back 58 and the electron-emitting device 54 is approximately 0.1 to 8 mm, and the voltage between the metal back 58 and the electron-emitting device 54 is approximately 0.1 to 10 kV.

### Embodiment

The present invention will be described below more in detail by citing embodiments.

In each embodiment to be described below, as a multi-electron beam source, the multi-electron beam source is used, in which the surface conductive electron-emitting devices of n×m pieces (n=480 and m=100) of the type having an electron-emitting portion in a conductive thin film between the device electrodes are wired by the row direction wirings of m pieces and the column directional wirings of n pieces in a matrix pattern.

### First Embodiment

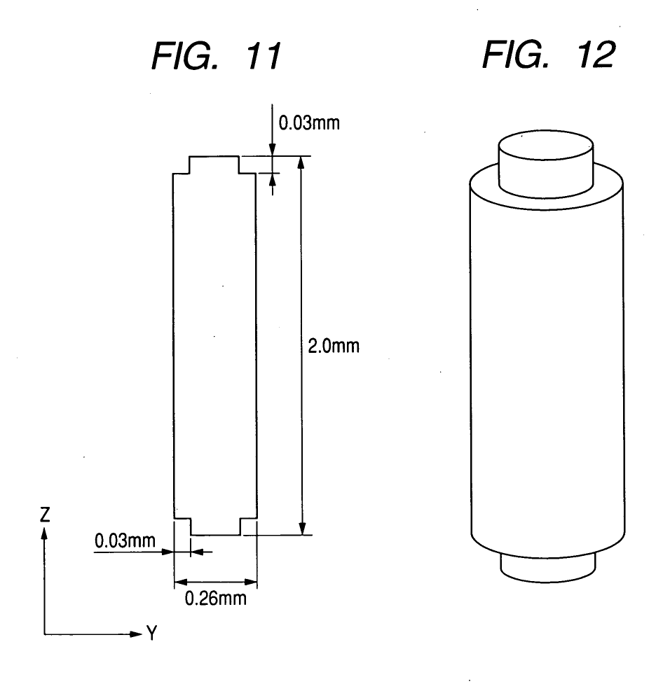

In the present embodiment, an image display apparatus of the constitution shown in FIG. 1A is formed. As an inslative base material 81 of a spacer 4 shown in FIG. 8, as shown in FIG. 11, a glass of the same quality as a rear plate of Length 108 mm×Width 2 mm×Thickness 0.26 mm having the shape notched at an end portion of Width 0.03 mm×Height 0.03 mm is prepared. (FIG. 8 is a schematic cross sectional view, and as for the shape of the spacer, please refer to FIG. 11). As a high resistance film 82, the targets of W and Ge are subjected to a co-sputtering in the atmosphere mixed with argon and nitride by using a sputtering device, and nitride films of W and Ge are laminated by thickness of 200 nm. The specific resistance of the prepared nitride films of W and Ge is 5.0×10⁵ Ω·m.

The thickness of a face plate 1 is T1=2.8 mm, the thickness of a rear plate 2 is T2=2.8 mm, and substrate intervals are D=2 mm. The inner size of a side wall 3 is W1=112 mm in an X direction, and W2=72 mm in a Y direction. The side wall 3 and the face plate 1 and the rear plate 2 are hermetically adhered by frit glass (not shown). The spacers 4 are disposed at a pitch P1=24 mm in the Y direction, the number of pieces thereof is two. By these constituent members, the image display apparatus is constituted.

The preparation of the display panel in the present embodiment will be descried in detail by using FIGS. 5 and 6. First, a substrate 51 formed with row directional wirings 32, column directional wirings 52, interlayer insulating layers 60, device electrodes 31 and 61 of surface conductive electron-emitting devices, and conductive thin films 64 is fixed to the rear plate 2 in advance. Next, the spacers 4 are fixed parallel to the row directional wirings 32 (line width=300 am) at equal intervals on the row directional wirings 32 of the substrate 51. After that, 2 mm above the substrate 51, the face plate 1 attached with a fluorescent film 57 and a metal back 58 in the interior thereof is disposed through the side wall 3, and each junction of the rear plate 2, the face plate 1, and the side wall 3 is fixed. The junction between the substrate 51 and the rear plate 2, the junction between the rear plate 2 and the side wall 3, and the junction between the face plate 1 and the side wall 3 are coated with a frit glass (not shown), and are sealed by being sintered at 400° C. to 500° C. for more than 10 minutes in the atmosphere.

In the present embodiment, the fluorescent film 57, as shown in FIG. 7, adopts a stripe shape in which each color fluorescent material 72 extends in the column direction (Y direction), and a black color conductive material 71 uses the fluorescent film 57 which is disposed so as to separate not only each color fluorescent material 72 (R, G, and B), but also each pixel in the Y direction, and the spacer 4 is disposed within the black conductive material 71 region (line width=300 μm) parallel with the row direction (X direction) through the metal back 58. On the occasion of performing the sealing, since the each color fluorescent material 72 and each electron-emitting device 54 disposed on the substrate 51 must be matched, positioning between the rear plate 2 and the face plate 1 is sufficiently performed.

The interior of the air-tight container completed as described above is evacuated by a vacuum pump through an exhaust pipe (not shown) so as to reach a sufficient degree of vacuum, and after that, the feeding is made to each electron-emitting device 54 through the container outer terminals Dx1 to Dxm and Dy1 to Dyn via the row directional wirings 32 and the column directional wirings 52, and the energization forming and energization activation processing are performed, thereby preparing the multi-electron beam source.

Next, the exhaust pipe (not shown) is heated and welded by a gas burner in a degree of vacuum of 10⁻⁴ Pa so as to seal a peripheral container (air-tight container). Finally, to maintain a degree of vacuum after sealing, the getter processing is performed.

In the image display apparatus thus completed, each electron-emitting device 54 is applied with a scanning signal and a modulation signal, respectively, through the container outer terminals Dx1 to Dxm and Dy1 to Dyn by signal generating means (not shown) so as to emit electrons, and the metal back 58 is applied with high voltage through the high voltage terminal Hv so as to accelerate the emitting-electron beam to allow the electrons to hit upon the fluorescent film 57, so that each color fluorescent material 72 (R, G, and B of FIG. 7) is excited to emit light, thereby displaying an image. The voltage Va applied to the high voltage terminal Hv is taken as 3 to 10 kV, and the voltage Vf applied between each wiring 32 and each wiring 52 is taken as 14V.

In the present embodiment,
S1 and S2=(0.26−0.03×2)×108×2=43.2 mm²
A=112×72=8064 mm²
s1 and s2=13.88352
0.3S1=12.96≦s1=s2=13.88352≦0.003A=24.192,
and therefore, as a spacer, it is the image display apparatus having a desirable constitution having a sufficient electric connection with the spacer and the face plate and the rear plate, while having a volume sufficient enough to obtain a buckling strength. In this manner, light emitting spot rows at two-dimensionally equal intervals are formed in addition to the light emitting spot by emitted electrons from the electron-emitting device 54 at a position in the vicinity to the spacer 4, thereby making it possible to perform a color image display of clear and good color reproductivity.

### Second Embodiment

A second embodiment of the present invention will be described on the points alone which are different from the first embodiment.

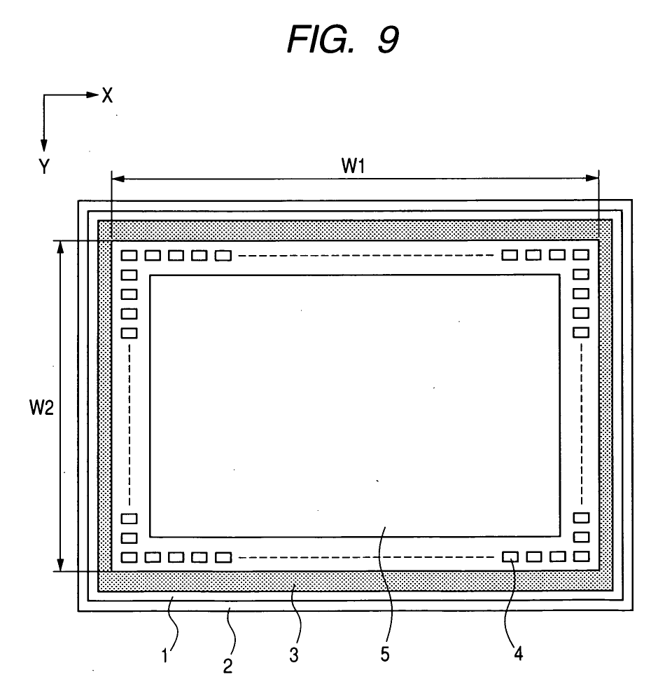

In FIG. 9 is shown a top plan schematic illustration of an image display apparatus of the present embodiment. Reference numerals in the drawing denote the same members as FIGS. 1A and 1B. The difference between the present embodiment and the first embodiment is that the shape of a spacer 4 is a square pole or rectangular column.

Through the provision of such a constitution, there is an advantage of making it possible to uniformly dispose spacers 4 and stabilize abutting states thereof, so that the beam incident position can be accurately controlled.

In the present embodiment, a cross section cut by a plane parallel with a face plate in the center portion (center between a face plate and a rear plate) of the spacer is a rectangle of 0.26 mm×0.46 mm as a spacer 4, and moreover, a cross section cut by a plane parallel with the face plate in the end portion adjacent and opposed to the face plate or the rear plate of the spacer is a rectangle of 0.2 mm×0.4 mm, and glass of the same quality as the rear plate which is 2 mm in height is prepared for 504 pieces, and the intervals between the adjacent spacers 4 are 4 mm both lengthwise and crosswise.

In the present embodiment,
S1 and S2=(0.26−0.03×2)×(0.46−0.03×2)×504=40.32 mm²
A=112×72=8064 mm²
s1 and s2=13.88352
0.3S1=12.096<s1=s2=13.88352≦0.003A=24.192,
and therefore, as a spacer, it is the image display apparatus having a desirable constitution having a sufficient electric connection with the spacer and the face plate and the rear plate, while having a volume sufficient enough to obtain a buckling strength. In this manner, light emitting spot rows at two-dimensionally equal intervals are formed in addition to the light emitting spot by emitted electrons from the electron-emitting device 54 at a position in the vicinity to the spacer 4, thereby making it possible to perform a color image display of clear and good color reproductivity.

### Third Embodiment

A third embodiment of the present invention will be described on the points alone which are different from the second embodiment.

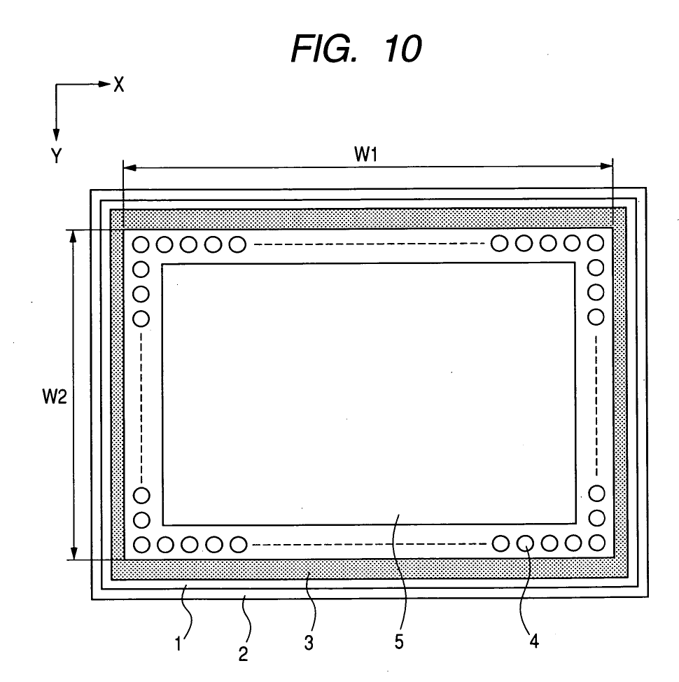

In FIG. 10 is shown a top plan schematic illustration of an image display apparatus of the present embodiment. Reference numerals in the drawing denote the same members as FIGS. 1A and 1B. The difference between the present embodiment and the second embodiment is that the shape of a spacer 4 is cylindrical. Through the provision of such a constitution, there is an advantage of making it possible to uniformly dispose spacers 4 and stabilize abutting states thereof, so that a beam incident position can be accurately controlled. Further, since the cross section is circular, it does not have a rotating dependability similarly to a polygonal cylinder, and it has an advantage of being easily assembled.

In the present embodiment, as the spacer 4 having the shape shown in FIG. 12, the diameter of the cross section cut by a plane parallel with a face plate in the center portion (center between a face plate and a rear plate) of the spacer is 0.29 mm, and moreover, the diameter of the cross section cut by a plane parallel with a face plate in the end portion adjacent and opposed to the face plate or the rear plate of the spacer is 0.25 mm, and cylindrical glass of the same quality of the rear plate which is 2 mm in height is prepared for 504 pieces, and the intervals between the adjacent spacers 4 are 4 mm both lengthwise and crosswise.

In the present embodiment,
S1 and S2=(0.25/2)²×π×504=24.74 mm²
A=112×72=8064 mm²
s1 and s2=13.88352
0.3S1=7.42≦s1=s2=13.88352≦0.003A=24.192,
and therefore, as a spacer, it is the image display apparatus having a desirable constitution having a sufficient electric connection with the spacer and the face plate and the rear plate, while having a volume sufficient enough to obtain a buckling strength. In this manner, light emitting spot rows at two-dimensionally equal intervals are formed in addition to the light emitting spot by emitted electrons from the electron-emitting device 54 at a position in the vicinity to the spacer 4, thereby making it possible to perform a color image display of clear and good color reproductivity.

### Fourth Embodiment

A fourth embodiment of the present invention will be described on the points alone which are different from the first embodiment.

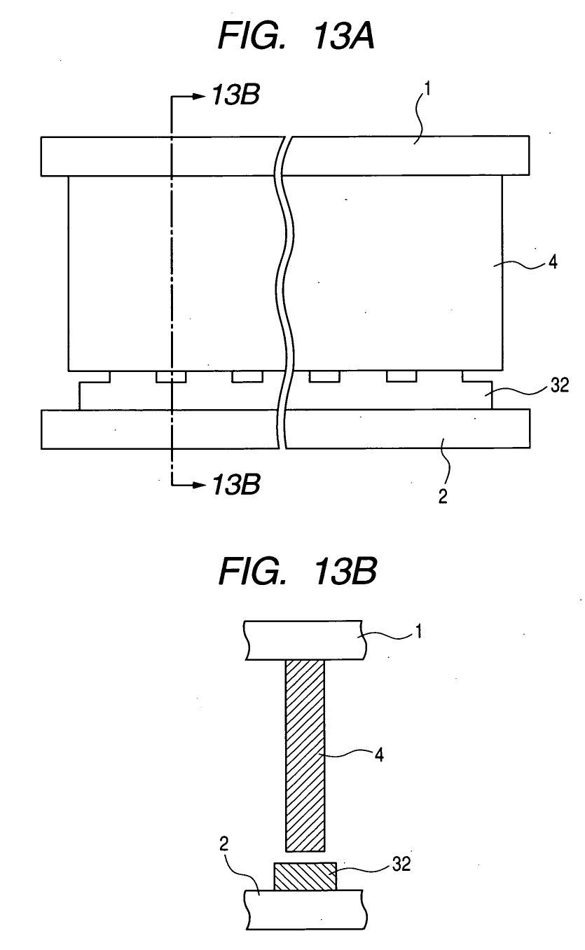

FIG. 13A is a drawing preferably representing the present embodiment, and FIG. 13B is a cross sectional schematic illustration cut along the line 13B-13B of FIG. 13A. The difference with the first embodiment is that the row directional wiring 32 on the rear plate 2 contacted by the spacer 4 has unevenness at the abutting surface of the spacer 4. Through the provision of such a constitution, the area in which the spacer 4 and the row directional wiring 32 are adjacent and opposed can be reduced without processing the spacer, which is difficult to process.

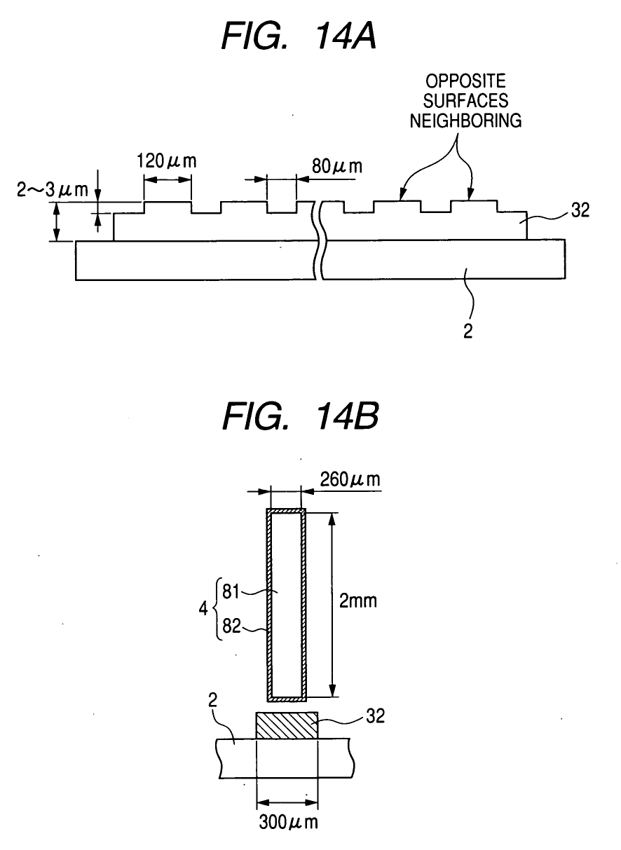

In the present embodiment, as shown in FIGS. 14A and 14B, as the insulative base material 81 of the spacer 4, glass of the same quality as the rear plate 2 of Length 108 mm×Width 2 mm×Thickness 0.26 mm is prepared, and as the row directional wiring 32, a concave portion of Width 300 μm at Intervals of 120 μm×Length 80 μm×Depth 2 to 3 μm is provided for 540 pieces.

In the present embodiment,
S1 and S2=0.26×(108−540×0.08)×3=50.5 mm²
A=112×72=8064 mm²
s1 and s2=13.88352
0.3S1=7.42≦s1=s2=13.88352≦0.003A=24.192,
and therefore, as a spacer, it is the image display apparatus having a desirable constitution having a sufficient electric connection with the spacer and the face plate and the rear plate, while having a volume sufficient enough to obtain a buckling strength. In this manner, light emitting spot rows at two-dimensionally equal intervals are formed in addition to the light emitting spot by emitted electrons from the electron-emitting device 54 at a position in the vicinity to the spacer 4, thereby making it possible to perform a color image display of clear and good color reproductivity.

Even when the rear plate structure of the present embodiment and the spacers of the first to third embodiments are combined, the same advantage can be obtained.

[The advantages of the Invention]

According to the present invention, an anti-atmospheric structure of the interior is suitably maintained by the spacer having sufficient buckling strength obtained by sufficient volume, and at the same time, the electric connection between the spacer coated with a high resistance film and first and second electrodes becomes good, and the effect to the image quality by the spacer can be also prevented. Hence, in the image display apparatus of the present invention, an image of high quality superior to the conventional image can be provided.

This application claims priority from Japanese Patent Applications No. 2004-162967 filed Jun. 1, 2004 and 2005-145081 filed on May 18, 2005, which is hereby incorporated by reference herein.

1. An image display apparatus, comprising:
a vacuum container comprising a first substrate having a first electrode, and a second substrate having a second electrode set at a potential higher than said first electrode; and
a spacer which is disposed in the interior of said vacuum container so as to abut against said first substrate and said second substrate, and comprises a base material and a film having resistance higher than said first electrode or second electrode coating the base material,
wherein 0.3S1≦s1≦0.003A or 0.3S2≦s2≦0.003A, where A is an inner cross sectional area of the container cut along a plane parallel with the first substrate of the vacuum container, S1 is a total area of the end portion adjacent and faced to the first substrate of the spacer, S2 is a total area of the end portion adjacent and faced to the second substrate of the spacer, s1 is an actual contact area with the spacer and the first electrode, and s2 is an actual contact area with the spacer and the second electrode.

2. The image display apparatus according to claim 1, wherein the sheet resistance of said high resistance film is 10⁷ to 10¹⁴ Ω/□.

3. The image display apparatus according to claim 1, wherein said first substrate has a plurality of electron-emitting devices.

4. The image display apparatus according to claim 3, wherein said first electrode is a wiring connected to said electron-emitting device, and said spacer is disposed on said wiring.
